(19) United States
(12) Patent Application Publication
(10) Pub. No.: US 2022/0157477 A1
(43) Pub. Date: May 19, 2022

(54) MATERIALS FOR NUCLEAR FUSION

(71) Applicant: HB11 Energy Holdings Pty Limited, Freshwater NSW (AU)

(72) Inventor: Warren McKenzie, Freshwater NSW (AU)

(21) Appl. No.: 17/524,021

(22) Filed: Nov. 11, 2021

(30) Foreign Application Priority Data
Nov. 13, 2020 (AU) 202090404168

(51) Int. Cl. G21B 3/00; G21B 1/05

(52) U.S. Cl. CPC G21B 3/006; G21B 1/05; G21B 3/002

(57) ABSTRACT

Described herein is a method of producing energy by proton-boron nuclear fusion, comprising non-thermally igniting a boron nitride nanomaterial (nBN) target by use of a laser emitting a laser beam, wherein the nBN comprises hydrogen. Also described herein is a system for conducting non-thermal ignition proton-boron nuclear fusion, comprising a target comprising hydrogen in a boron nitride nanomaterial (nBN) matrix and a laser positioned to irradiate the target and thereby initiate a nuclear fusion reaction.

### CROSS-REFERENCE

This application claims priority to Australian Provisional Patent Application Number 2020904168, filed on 13 Nov. 2020, which is incorporated by reference in its entirety.

### FIELD

The present invention relates to the field of nuclear fusion. More particularly, the invention relates to materials useful for proton-boron fusion.

### BACKGROUND

Any discussion of the prior art throughout the specification should in no way be considered as an admission that such prior art is widely known or forms part of common general knowledge in the field.

Nuclear fusion reactions are those in which two or more atomic nuclei combine to form one or more different nuclei and, optionally, release of subatomic particles. For light nuclei, the difference in mass between the starting nuclei and the final product(s) is released as energy. This energy can be captured and used, for instance, to generate electricity.

For example, when a hydrogen nucleus (also referred to as a proton, p) hits a boron-11 atom, it may ignite a nuclear fusion reaction according to Equation 1, resulting in creation of three helium nuclei (a particles) and release of energy (hereinafter referred to as “the HB11 reaction”):

p+¹¹B→3α+8.7 MeV Equation 1

The reaction of Equation 1 is aneutronic, meaning that the reaction releases most of its energy in the form of charged α particles rather than in the form of neutrons. This reaction thus has advantages over fusion reactions that release neutrons because neutrons are a source of ionising radiation and therefore present problems in terms of shielding and safety.

The HB11 reaction is also able to be conducted non-thermally using pulsed high-powered lasers. This is significant, because almost all other efforts to date to achieve fusion reactions rely on reactors capable of generating extremely high temperatures (exceeding 100 million degrees Celsius) to energise the particles sufficiently for fusion events to occur. By contrast, non-thermal fusion uses pulses from a high-peak-powered laser (or chirped pulse amplification (“CPA”) laser) to accelerate hydrogen nuclei through a boron-11-containing sample. This has been referred to as laser induced acceleration of protons as “plasma block acceleration” or “laser ion acceleration”.

Non-thermal ignition of the HB11 reaction using lasers has been observed experimentally, where a particle yields of ˜10⁵α particles/steradian (α/sr) and ˜10⁹ α/sr have been observed for targets made from boron-polymer composites and boron-implanted silicon wafers chemically enriched with hydrogen, respectively. These yields have been attributed to secondary reactions of high energy alpha particles produced by the initial HB11 reaction going on to energise protons that collide with boron atoms in the target. Reactions between alpha particles produced by these secondary reactions and protons and boron atoms, and the rounds of fusion events that follow, is known as the “avalanche effect” and is the first step towards enabling net energy gain from a fusion system. More specifically, the avalanche effect is thought to proceed as follows:

p+¹¹B→α_{2.9 keV}+α_{2.9 keV}+α_{2.9 keV} Equation 1a

α_{2.9 keV}+pᵣₑₛₜ→α_{1.04 keV}+p_{1.86 keV} Equation 2

α_{1.04 keV}+pᵣₑₛₜ→α_{0.375 keV}+p_{0.665 keV} Equation 2a

p_{0.665 keV}+¹¹Bᵣₑₛₜ→p¹¹B_{0.612 keV}→3_{α2.9 keV} Equation 1b

To date, the largest observed reaction gains for the HB11 reaction have been in the order of 10¹¹ α/sr using a target comprising boron nitride (“BN”) crystals. Although a separate CH foil proton source was used in this experiment, the BN crystals in the target inherently contained hydrogen (about 1 wt %) left over from the chemical processing method used to make the BN. Notwithstanding this, and the high a particle yield, no avalanche reaction was reported.

There is therefore a need in the art for alternative HB11 fusion reaction targets, and in particular, HB11 fusion reaction targets capable of sustaining an avalanche reaction.

It is an object of the present invention to overcome or ameliorate at least one of the disadvantages of the prior art, or to provide a useful alternative.

### SUMMARY

Described herein is the use of boron nitride (“nBN”) nanomaterials comprising hydrogen in non-thermal ignition proton-boron nuclear fusion.

In preferred embodiments, the nBNs comprising hydrogen as described herein represent materials useful as new targets for the HB11 reaction. These materials advantageously contain high densities of boron and a much higher density of hydrogen than can be achieved in doped bulk BN crystals, which typically contain about 1 wt % hydrogen residual from synthesis of the BN (Margarone et. al. (2020), Frontiers in Physics, 8, 343). Furthermore, they can easily be formed into a variety of shapes for use in a range of fusion reactor designs. In some embodiments, the nBNs comprising hydrogen as described herein can be formed into dense cylindrical shapes for use in emerging non-thermal ignition fusion reactor designs. In preferred embodiments, the nBNs comprising hydrogen as described herein are capable of sustaining avalanche fusion reactions once ignited.

According to a first aspect of the invention there is provided use of a boron nitride nanomaterial (nBN) in non-thermal ignition proton-boron nuclear fusion, wherein the nBN comprises hydrogen. The following features may be used alone or in combination with the first aspect above:

The nBN comprising hydrogen may be a non-thermal ignition proton-boron nuclear fusion target. The nBN comprising hydrogen is a non-thermal ignition proton-boron nuclear fusion fuel. The nBN may have at least one external dimension, or at least one surface structure dimension, of from about 0.05 nm to about 100 nm. In one embodiment, the nBN may have at least one external dimension, or at least one surface structure dimension, of about 0.85 nm to about 100 nm. The nBN may comprise BN nanosheets, nanotubes, micro/mesoporous nanosheets and nanotubes, porous hexagonal BN, milled hexagonal BN, porous turbostratic BN, porous BN microbelts, porous sponge-like BN, multiwalled BN nanotubes, bamboo-like BN nanotubes, collapsed BN nanotubes, BN nanospheres, hollow BN nanospheres, BN nanomesh, BN nanowires, or BN aerogel, or a combination of any two or more of these. The nBN may comprise BN nanosheets. The nBN may be in the form of BN nanosheets. The nBN may comprise exfoliated BN nanosheets. The BN nanosheets may be exfoliated by ball milling BN. The BN nanosheets may have an external dimension that corresponds to a surface structure dimension of about 0.09 nm. The nBN may have a surface area of from 500 to 2000 m²/g. The nBN may comprise at least 4 wt % hydrogen. The nBN may comprise at least 5 wt % hydrogen. The nBN may comprise at least about 4 wt % hydrogen. The nBN may comprise at least about 5 wt % hydrogen. The nBN may comprise at least about 20 wt % hydrogen. The nBN may comprise at least about 50 wt % hydrogen. The hydrogen may be present in the nBN at a concentration of between about 50 and about 75 at % H. The nBN may comprise exogenous hydrogen. The hydrogen may be physisorbed in the nBN. The hydrogen may be chemisorbed in the nBN. The nBN may be enriched in ¹¹B. The nBN may have a ¹⁰B:¹¹B ratio of between 1:99 and 20:80. The nBN comprising hydrogen may sustain an avalanche fusion reaction. Tertiary α-particles may be produced by non-thermal ignition proton-boron nuclear fusion reaction of the nBN comprising hydrogen. The nBN comprising hydrogen may be formed into a pellet by powder pressing. The pellet may be cylindrical in shape. The nBN comprising hydrogen may have a density of between 1 and 3 g/cm³.

According to a second aspect of the invention there is provided a method of producing energy by proton-boron nuclear fusion, comprising non-thermally igniting a boron nitride nanomaterial (nBN) comprising hydrogen.

According to a third aspect of the invention there is provided a method of producing tertiary α-particles comprising non-thermally igniting a boron nitride nanomaterial (nBN) comprising hydrogen.

The following features may be used alone or in combination with the second or third aspects above:

Alpha particles produced by the fusion reaction may have a kinetic energy of up to 20 MeV. The boron nitride nanomaterial (nBN) comprising hydrogen may be a target. The nBN comprising hydrogen may be as defined for the first aspect above. Non-thermal ignition may be achieved by use of a laser emitting a laser beam. A single laser may be used to ignite the target. The laser beam may directly irradiate the nBN comprising hydrogen. The laser beam may be focused onto the nBN comprising hydrogen. The laser beam may have a focal spot on the nBN having a diameter of between 5 μm and 500 μm. The laser beam may be emitted by a laser unit positioned at a distance of between 0.1 and 0.5 m from the nBN comprising hydrogen. The laser beam may emit light having a wavelength of between 500 nm and 2000 nm. The laser may deliver laser beam pulses having a FWHM pulse duration of between 1 ps and 10 ns. The laser may deliver laser beam pulses having a FWHM pulse duration of between 1 fs and 1 ns. The laser may deliver laser beam pulses having a pulse energy of between 10 and 3000 J. The laser may deliver laser beam pulses having a pulse energy of between 10 and 200 J. The laser may deliver laser beam pulses having a pulse energy of between 200 and 3000 J. The laser beam may emit light having a wavelength of 1050 nm, a FWHM pulse duration of 2.6 ps and a pulse energy of 1400 J. The laser beam may have an intensity of between 1×10¹⁵ and 1×10²⁰ W/cm² on the nBN comprising hydrogen. The laser beam may have an intensity of between 1×10¹⁹ and 1×10²² W/cm² on the nBN comprising hydrogen. Alternatively, the laser may have a shorter but more intense pulse, with a pulse length of between 1 as and 1 fs, an intensity of between 1×10²⁵ W/cm² and 1×10²⁶ W/cm² and an energy of between 0.1 J and 10 J. The laser may be a chirped pulse amplification laser. The laser may ignite a fusion reaction that yields at least 1×10¹⁴ α/sr/shot. The laser may ignite a fusion reaction that yields at least 1×10¹⁶ α/sr/shot. An avalanche fusion reaction may be ignited in the nBN comprising hydrogen.

In one embodiment, there is described herein a method of producing energy by proton-boron nuclear fusion, comprising non-thermally igniting a boron nitride nanomaterial (nBN) target by use of a laser emitting a laser beam, wherein the nBN comprises hydrogen. In this embodiment, the nBN comprising hydrogen may be a non-thermal ignition proton-boron nuclear fusion target. The nBN comprising hydrogen is a non-thermal ignition proton-boron nuclear fusion fuel. The nBN may have at least one external dimension, or at least one surface structure dimension, of from about 0.05 nm to about 100 nm. In one embodiment, the nBN may have at least one external dimension, or at least one surface structure dimension, of about 0.85 nm to about 100 nm. The nBN may comprise BN nanosheets, nanotubes, micro/mesoporous nanosheets and nanotubes, porous hexagonal BN, milled hexagonal BN, porous turbostratic BN, porous BN microbelts, porous sponge-like BN, multiwalled BN nanotubes, bamboo-like BN nanotubes, collapsed BN nanotubes, BN nanospheres, hollow BN nanospheres, BN nanomesh, BN nanowires, or BN aerogel, or a combination of any two or more of these. The nBN may comprise BN nanosheets. The nBN may be in the form of BN nanosheets. The nBN may comprise exfoliated BN nanosheets. The BN nanosheets may be exfoliated by ball milling BN. The BN nanosheets may have an external dimension that corresponds to a surface structure dimension of about 0.09 nm. The nBN may have a surface area of from 500 to 2000 m²/g. The nBN may comprise at least 4 wt % hydrogen. The nBN may comprise at least 5 wt % hydrogen. The nBN may comprise at least about 4 wt % hydrogen. The nBN may comprise at least about 5 wt % hydrogen. The nBN may comprise at least about 20 wt % hydrogen. The nBN may comprise at least about 50 wt % hydrogen. The hydrogen may be present in the nBN at a concentration of between about 50 and about 75 at % H. The nBN may comprise exogenous hydrogen. The hydrogen may be physisorbed in the nBN. The hydrogen may be chemisorbed in the nBN. The nBN may be enriched in ¹¹B. The nBN may have a ¹⁰B:¹¹B ratio of between 1:99 and 20:80. The nBN comprising hydrogen may sustain an avalanche fusion reaction. Tertiary α-particles may be produced by non-thermal ignition proton-boron nuclear fusion reaction of the nBN comprising hydrogen. The nBN comprising hydrogen may be formed into a pellet by powder pressing. The pellet may be cylindrical in shape. The nBN comprising hydrogen may have a density of between 1 and 3 g/cm³.

According to a fourth aspect of the invention there is provided a system for conducting non-thermal ignition proton-boron nuclear fusion, comprising: a target comprising hydrogen in a boron nitride nanomaterial (nBN) matrix; and a laser positioned to irradiate the target and thereby initiate a nuclear fusion reaction.

The following features may be used alone or in combination with the fourth aspect above:

The system may further comprise: an assembly configured to convert energy from charged particles produced by the nuclear fusion reaction into electrical energy. The assembly may be an electrically conductive sphere encasing the target. The target may be confined in a magnetic field. The magnetic field may have a strength of between 0.8 and 12 kT. The magnetic field may be induced by magnetic field laser pulses. The system may be a reactor. The nBN matrix comprising hydrogen may be an nBN comprising hydrogen as defined for the first aspect above. The target may comprise an outer casing or outer layer on the nBN. The laser or laser beam emitted by the laser may be as defined for the second or third aspects above. The laser may ignite a fusion reaction in the target that yields at least 1×10¹⁴ α/sr/shot. Alpha particles produced by the nuclear fusion reaction may have a kinetic energy of up to 20 MeV. The target may sustain an avalanche fusion reaction.

In one embodiment, there is disclosed use of a boron nitride nanomaterial (nBN) as a non-thermal ignition proton-boron nuclear fusion fuel, wherein the nBN comprises hydrogen, wherein the nBN comprises BN nanosheets having at least one external dimension corresponding to a surface structure dimension of from about 0.85 nm to about 1 nm, wherein the nBN has a surface area of from 500 to 2000 m²/g, and wherein the hydrogen is present in the nBN at a concentration of between about 50 and about 75 at % H.

In one embodiment, there is disclosed a method of producing energy by proton-boron nuclear fusion, comprising non-thermally igniting a target comprising a boron nitride nanomaterial (nBN) comprising hydrogen, wherein the nBN comprises BN nanosheets having at least one external dimension corresponding to a surface structure dimension of from about 0.85 nm to about 1 nm, wherein the nBN has a surface area of from 500 to 2000 m²/g, and wherein the hydrogen is present in the nBN at a concentration of between about 50 and about 75 at % H.

In another embodiment, there is disclosed a method of producing energy by proton-boron nuclear fusion, comprising non-thermally igniting a target comprising a boron nitride nanomaterial (nBN) comprising hydrogen with a chirped pulse amplification laser emitting a laser beam, wherein the nBN comprises BN nanosheets having at least one external dimension corresponding to a surface structure dimension of from about 0.85 nm to about 1 nm, wherein the nBN has a surface area of from 500 to 2000 m²/g, and wherein the hydrogen is present in the nBN at a concentration of between about 50 and about 75 at % H, and wherein the laser beam has an intensity of between 1×10¹⁵ and 1×10²⁰ W/cm² on the nBN comprising hydrogen.

In another embodiment, there is disclosed a method of producing energy by proton-boron nuclear fusion, comprising non-thermally igniting a target comprising a boron nitride nanomaterial (nBN) comprising hydrogen with a chirped pulse amplification laser emitting a laser beam, wherein the nBN comprises BN nanosheets having at least one external dimension corresponding to a surface structure dimension of from about 0.85 nm to about 1 nm, wherein the nBN has a surface area of from 500 to 2000 m²/g, and wherein the hydrogen is present in the nBN at a concentration of at least 4 wt %, and wherein the laser beam has an intensity of between 1×10¹⁵ and 1×10²⁶ W/cm² on the nBN comprising hydrogen.

In a further embodiment, there is disclosed a reactor for conducting non-thermal ignition proton-boron nuclear fusion, comprising: a target comprising hydrogen in a boron nitride nanomaterial (nBN) matrix, a chirped pulse amplification laser positioned to irradiate the target and thereby initiate a nuclear fusion reaction, and an assembly configured to convert energy from charged particles produced by the nuclear fusion reaction into electrical energy, wherein the nBN comprises BN nanosheets having at least one external dimension corresponding to a surface structure dimension of from about 0.85 nm to about 1 nm, wherein the nBN has a surface area of from 500 to 2000 m²/g, and wherein the hydrogen is present in the nBN at a concentration of between about 50 and about 75 at % H, and wherein the laser beam has an intensity of between 1×10¹⁵ and 1×10²⁰ W/cm² on the nBN comprising hydrogen.

### BRIEF DESCRIPTION OF THE DRAWINGS

Preferred embodiments of the invention will now be described, by way of example only, with reference to the accompanying drawings in which:

FIG. 1 shows diagrammatically a simplified primary, secondary, tertiary and 4^{th} order HB11 reaction sequence and the primary α-particles 1, secondary α-particles 2, and tertiary α-particles 3 produced by each reaction. Key: ≈=ignition energy source; ●=proton; ◯=boron nucleus.

FIG. 2 shows diagrammatically an experiment to generate α-particles from an HB11 fusion target.

FIG. 3: Image from SRIM simulation of damage cascades in boron nitride samples with 50 at % hydrogen from (a) 600 KeV implantation of H, and (b) 2.9 MeV implantation of an alpha particle. In both cases, the He and H ion beam is incident on the target from the left.

FIG. 4: P(avalanche) calculated from SRIM simulation as a function of hydrogen content in a boron nitride sample.

FIG. 5: Microgram of a CR39 detector (710 μm wide and 540 μm high) used to detect alpha particles generated by non-thermal fusion reactions initiated by a petawatt laser irradiating a target of boron-nitride nanosheets comprising hydrogen. The CR39 detector was developed to reveal the alpha-particle tracks.

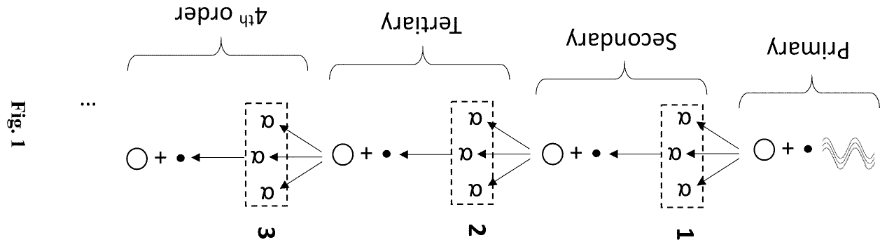

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

Other than in the operating examples, or where otherwise indicated, all numbers expressing quantities of ingredients or reaction conditions used herein are to be understood as modified in all instances by the term ‘about’.

In what follows, or where otherwise indicated, ‘%’ will mean ‘weight %’, ‘ratio’ will mean ‘weight ratio’. As used herein, the term “weight %” or “wt %” is calculated as [100×mₓ/mₜₒₜ], where mₓ is the mass of component x and mₜₒₜ is the total mass of all components, including component x.

As used herein, ‘at %’ will mean ‘atomic %’ and is calculated as [100×Nₓ/Nₜₒₜ], where Nₓ is the number of atoms of component x and Nₜₒₜ is the total number of atoms, including atoms x.

The term ‘substantially’ as used herein shall mean comprising more than 50% by weight, where relevant, unless otherwise indicated.

The recitation of a numerical range using endpoints includes the endpoints and all numbers subsumed within that range (that is, from 1 to 10 includes 1, 1.5, 2, 5, 5.75, 7.1, 8.5, 9, 10, etc.).

The terms ‘preferred’ and ‘preferably’ refer to embodiments of the invention that may afford certain benefits, under certain circumstances. However, other embodiments may also be preferred under the same or other circumstances. Furthermore, the recitation of one or more preferred embodiments does not imply that other embodiments are not useful and is not intended to exclude other embodiments from the scope of the invention.

As used herein and in the claims, the singular form of “a”, “an”, and “the” may include the plural referents unless the context clearly dictates otherwise.

As used herein, the terms “about” and “approximately” are used synonymously. Both terms are meant to cover any normal fluctuations or variations understood by those skilled in the art. In some embodiments, “about” and “approximately” refer to ±10% of the reference value, or ±5%, or ±2%, or ±1%, or ±0.1% of the reference value.

In this application, the use of “or” means “and/or” unless stated otherwise.

As used herein, the term “primary HB11 fusion reaction” refers to a fusion reaction between a proton energised by an ignition source external to the nBN comprising hydrogen and a boron nucleus in the nBN. In some embodiments, the ignition source is a laser. For convenience, α-particles produced by a primary HB11 fusion reaction are termed “primary α-particles”.

As used herein, the term “secondary HB11 fusion reaction” refers to a fusion reaction that occurs when a primary α-particle produced from a primary HB11 fusion reaction energises one or more protons that then react with boron nuclei in the nBN material. For convenience, α-particles produced by a secondary HB11 fusion reaction are termed “secondary α-particles”.

As used herein, the term “tertiary HB11 fusion reaction” refers to a fusion reaction that occurs when a secondary α-particle produced from a secondary HB11 fusion reaction energises one or more protons that then react with boron nuclei in the nBN material. For convenience, α-particles produced by a tertiary HB11 fusion reaction are termed “tertiary α-particles”.

As used herein, an nth order HB11 fusion reaction (where n is any positive integer >1) refers to a fusion reaction that occurs when an (n−1)th α-particle produced from an (n−1)th order HB11 fusion reaction energises one or more protons that then react with boron nuclei in the nBN material. For convenience, α-particles produced by an nth order HB11 fusion reaction are termed “nth order α-particles”.

As used herein, the term “avalanche” and related terms such as “avalanche reaction” and “avalanche fusion reaction” in relation to HB11 fusion reactions refer to the occurrence of tertiary or any subsequent nth order (where n>3) HB11 fusion reactions.

### DETAILED DESCRIPTION

The skilled addressee will understand that the invention comprises the embodiments and features disclosed herein as well as all combinations and/or permutations of the disclosed embodiments and features.

Described herein is use of a boron nitride nanomaterial (nBN) in non-thermal ignition proton-boron nuclear fusion, wherein the nBN comprises hydrogen. Boron nitride nanomaterial, that is, boron nitride having at least one external dimension or at least one surface structure dimension in the nanoscale, is advantageously capable of containing or storing hydrogen in quantities that exceed that of single crystal or coarse-grained forms of boron nitride.

As used herein, the term “nanomaterial” refers to a material having at least one external dimension or at least one surface structure dimension in the nanoscale, where the nanoscale is defined as a length range of from about 0.05 nm to about 100 nm. In preferred embodiments, the nanomaterial has at least one external dimension or at least one surface structure dimension at a length range of from 0.085 nm to 100 nm. In one embodiment, the nanomaterial has an external dimension that corresponds to a surface structure dimension of about 0.09 nm, which is the thickness of a single layer of hexagonal BN. In preferred embodiments, the nanomaterial is engineered nanomaterial, meaning that the nanomaterial is artificially created and/or modified to have at least one external dimension or at least one surface structure dimension in the nanoscale. Methods for engineering a nanomaterial are discussed below.

Inclusion of sufficient quantities of hydrogen in a nBN described herein may provide a ready source of protons needed for the HB11 reaction in close proximity to co-reactant boron atoms. In this way, when used for non-thermal ignition proton-boron nuclear fusion, the nBN material comprising hydrogen described herein may be capable of sustaining avalanche fusion reactions.

In a preferred embodiment, a nBN comprising hydrogen as described herein is used as a proton-boron nuclear fusion target. The term “target” in this context refers to a non-thermal ignition source, in preferred embodiments laser irradiation, being directed towards and/or being incident on the nBN comprising hydrogen.

A nBN comprising hydrogen as described herein may be used as a proton-boron nuclear fusion fuel. The term “fuel” in this context refers to the nBN comprising hydrogen being used as a source of energy via proton-boron nuclear fusion reactions initiated by a non-thermal ignition source.

Any suitable form of nBN may be used. The nBN may comprise BN nanosheets, nanotubes, micro/mesoporous nanosheets and nanotubes, porous hexagonal BN, milled hexagonal BN, porous turbostratic BN, porous BN microbelts, porous sponge-like BN, multiwalled BN nanotubes, bamboo-like BN nanotubes, collapsed BN nanotubes, BN nanospheres, hollow BN nanospheres, BN nanomesh, BN nanowires, or BN aerogel, or a combination of any two or more of these. In some embodiments, the nBN may comprise BN nanosheets, nanotubes, micro/mesoporous nanosheets and nanotubes, porous hexagonal BN, or milled hexagonal BN, or a combination of any two or more of these forms. In other embodiments, the nBN may be in the form of BN nanosheets, nanotubes, micro/mesoporous nanosheets and nanotubes, porous hexagonal BN, or milled hexagonal BN, or a combination of any two or more of these forms.

The nBN herein may comprise BN nanosheets. In one embodiment, the nBN is in the form of BN nanosheets. BN nanosheets (also known as “white graphene”) comprise two-dimensional sheets of sp² hybridised boron and nitrogen atoms arranged in a hexagonal lattice, giving rise to a honeycomb-like structure similar to that of graphene. BN nanosheets may be referred to as hexagonal BN or “h-BN”. Multi-layered stacks of individual BN nanosheets may form, which are held together by Van der Waals forces. Nanosheets of BN may be synthesised by methods known in the art, such as by chemical vapour deposition of borazine, borazane or adducts of boron trihalides and ammonia (Jana & Singh (2018) International Materials Reviews, 63, 162) or may be obtained from h-BN made by a batch synthesis process comprising reacting boron trioxide (B₂O₃) or boric acid (H₃BO₃) with ammonia (NH₃) or urea (CO(NH₂)₂) in a nitrogen atmosphere and then annealing the resultant amorphous BN to temperatures of >1500° C. to crystallise (Chakrabartty and Kumar (1995). Preparation of hexagonal boron nitride from boric acid and characterization of the materials. Trans. Ind. Ceram. Soc. 54, 48). In some embodiments, the nBN nanosheets herein comprise milled h-BN nanosheets, including h-BN that has been milled or ground to produce small crystallites. In such embodiments, the h-BN may be milled h-BN that comprises exfoliated h-BN nanosheets. The exfoliated nanosheets may be atomically thin, in some embodiments having a single atom thickness of approximately 0.09 nm. In other embodiments, the BN nanosheets may comprise porous turbostratic BN nanosheets.

More generally, the nBN herein may comprise milled hexagonal BN. In one embodiment, the nBN is in the form of milled hexagonal BN. Milled hexagonal BN may be produced through the use of milling processes such as ball-milling. Ball-milling is known to disrupt the layered structures adopted by sheets of hexagonal BN, leading to changes in surface area and/or chemistry via processes such as oxidation. Ball-milling and subsequent annealing of amorphous BN may yield hexagonal BN nanosheets and/or nanotubes. In other embodiments, ball-milling of hexagonal BN may yield exfoliated hexagonal BN nanosheets and/or may yield BN nanotubes. Processes and parameters for ball-milling hexagonal BN are known in the art (Namba et al. (2019) Catal. Sci. Technol., 9, 302).

The nBN described herein may comprise BN nanotubes. In one embodiment, the nBN is in the form of BN nanotubes. Nanotubes of BN are cylindrical forms of boron nitride nanosheets having diameters in the sub- to micro-metre lengths and that are similar in structure to carbon nanotubes. Methods of synthesising BN nanotubes are known in the art and may include chemical vapour deposition processes or thermal annealing processes such as described in WO 2011/032231. In some embodiments, the BN nanotubes may comprise single walled nanotubes. In some embodiments, the BN nanotubes may comprise multi-walled nanotubes. The BN nanotubes may comprise bamboo-like nanotubes. The BN nanotubes may comprise collapsed nanotubes. The BN nanotubes may comprise a mixture of any two or more different types of BN nanotubes selected from multi-walled nanotubes, bamboo-like nanotubes, single walled nanotubes and collapsed nanotubes.

The nBN described herein may comprise micro/mesoporous BN comprising BN nanosheets or BN nanotubes. In one embodiment, the nBN is in the form of micro/mesoporous nanosheets or nanotubes. Micro/mesoporous BN comprise BN nanosheets and/or nanotubes having cavities or pores that are generally formed around template or structure-directing molecules (such as surfactants) and which are subsequently removed via processes such as pyrolysis. The micro/mesoporous nanosheets may be three-dimensional structures. In some embodiments, the micro/mesoporous nanosheets comprise interconnected fragments of two-dimensional nanosheets. In some embodiments, the micro/mesoporous nanosheets or nanotubes comprise amorphous BN domains. In one embodiment, the micro/mesoporous BN comprises porous networks of hexagonal BN nanosheets. In another embodiment, the micro/mesoporous BN comprises porous networks of hexagonal BN nanotubes. In some embodiments, the nBN comprises porous sponge-like BN. Methods of synthesising micro/mesoporous nanosheets or nanotubes and porous hexagonal BN include templating processes known in the art (Vinu et al., (2005) Chem. Mater., 17, 5887) and template-free thermal processes (Marchesini et al. (2017) ACS Nano, 11, 10003).

Other forms of nBN are also contemplated herein, and include porous BN microbelts, BN nanospheres, hollow BN nanospheres, BN nanomesh, BN nanowires, and BN aerogel.

The nBN described herein is advantageously capable of manufacture on a large scale. Accordingly, batch synthesis processes are preferred. Suitable batch syntheses may comprise reacting boron trioxide (B₂O₃) or boric acid (H₃BO₃) with ammonia (NH₃) or urea (CO(NH₂)₂) in a nitrogen atmosphere and then annealing the resultant amorphous BN to temperatures of >1500° C. to crystallise (see also Sen et al. (2018) Front Bioeng Biotechnol. 6, 83). BN nanosheets may then be extracted from synthesised h-BN by a process of exfoliation by any suitable method. Methods of exfoliation suitable for use in some embodiments may include mechanical exfoliation. Mechanical exfoliation may include ball milling. Examples of ball-milling process include Lei et al. (2015) Nature Communications, 6, 8849, which describes h-BN and urea being mixed together at the weight ratio 1:60 inside a steel milling container using a planetary ball mill at a rotation speed of 700 r.p.m. for 20 h at room temperature under nitrogen atmosphere. Other methods of exfoliation suitable for use in some embodiments may include liquid exfoliation. Liquid exfoliation methods may include sonication and centrifugation.

In a preferred embodiment, the nBN comprises exfoliated BN nanosheets. In such embodiments, the exfoliated BN nanosheets may be manufactured by a process of ball milling, which advantageously increases the surface area of the nBN by physically disrupting the layered structure of the hexagonal BN sheets. In some embodiments, ball-milling additionally results in chemical changes to the BN structure. The chemical changes may include introducing defects into the BN nanosheets such as amino- and hydroxyl groups, and/or may include oxidation of surface boron to form B—OH groups. The increased surface area enabled by exfoliation, optionally in combination with chemical changes in the BN nanosheets, may facilitate uptake of hydrogen in these nBN nanosheets.

In some embodiments, ball milling is used to exfoliate hexagonal BN to create an nBN suitable for use in the present invention. Whilst any suitable ball milling process may be used, in some embodiments, a planetary ball mill is used having a ball mill speed of between 100 rpm and 1000 rpm, or between 100 rpm and 500 rpm, or between 250 rpm and 750 rpm, or between 300 rpm and 600 rpm, or between 500 rpm and 700 rpm, or between 600 rpm and 1000 rpm, or at least 100 rpm, at least 200 rpm, or at least 300 rpm, or at least 400 rpm, or at least 500 rpm, or at least 600 rpm, or at least 700 rpm, or at least 800 rpm, or a speed of 100 rpm, 200 rpm, 300 rpm, 400 rpm, 500 rpm, 600 rpm, 700 rpm, 800 rpm, 900 rpm or 1000 rpm. Steel balls of any suitable size may be used. In some embodiments, steel balls having a diameter of 0.1 mm, or of 0.2 mm, or of 0.5 mm, or of 1 mm, or of 1.5 mm, or of 2 mm may be used, or steel balls having a diameter of between 0.5 mm and 2 mm, or of between 0.1 mm and 1 mm, or of between 0.1 mm and 0.5 mm, or of between 0.3 and 1.0 mm may be used.

Any suitable ball-to-powder ratio may be used. In some embodiments, a ball-to-powder weight ratio of 1:1, or 5:1, or 10:1, or 20:1, or 30:1, or 40:1, or 50:1 or 60:1, or 80:1, or 100:1 is used, or a ball-to-powder weight ratio of between 5:1 and 20:1, or of between 10:1 and 25:1, or of between 5:1 and 15:1, or of between 20:1 and 50:1 is used. The ball milling may be dry milling. Alternatively, a milling agent may be added. Any suitable milling agent may be used. However, in some embodiments, the milling agent is a liquid. In some embodiments, the milling agent is a liquid selected from water, ethanol, dodecane and benzyl benzoate. In one embodiment, the milling agent is water. In another embodiment, the milling agent is ethanol. In another embodiment, the milling agent is dodecane. In another embodiment, the milling agent is benzyl benzoate. In other embodiments, the milling agent is a solid. In one embodiment, the solid milling agent is urea. Any suitable proportion of milling agent may be used. In some embodiments, the ratio of milling agent to BN is about 100:1, or about 80:1, or about 60:1, or about 40:1, or about 20:1, or about 10:1, or about 1:1.

Any suitable milling time may be selected. In one embodiment, the milling time is about 2 h, or 4 h, or 6 h, or 8 h, or 10 h, or 12 h, or 15 h, or 20 h, or 25 h, or 30 h, or between 5 and 30 h, or between 1 and 5 h, or between 8 and 12 h, or between 10 and 20 h, or between 7 and 15 h, or between 15 and 25 h, or between 20 and 30 h. In some embodiments, the ball milling is conducted under an inert atmosphere. In one embodiment, the ball milling is conducted under a nitrogen atmosphere.

The nBN described herein may have any suitable crystallite size and distribution. The nBN may comprise crystallites having at least one dimension in the range of from 0.05 nm to 10 nm, or from 0.05 nm to 1 nm, or from 0.085 to 10 nm, or from 0.085 nm to 0.90 nm, or from 1 nm to 50 nm, or from 10 nm to 80 nm, or from 0.05 nm to 100 nm, or from 10 nm to 100 nm, or from 50 nm to 80 nm, or from 75 to 100 nm. The nBN may comprise crystallites having at least one dimension greater than 0.05 nm but less than 100 nm, or less than 80 nm, or less than 60 nm, or less than 40 nm, or less than 20 nm, or less than 10 nm, or less than 5 nm. In one embodiment, the crystallites have one dimension that corresponds to a single atom thickness of approximately 0.09 nm. In one embodiment, the nBN comprises crystallites have one dimension that corresponds to a single atom thickness of approximately 0.09 nm. In some embodiments, the crystallites having one dimension that corresponds to a single atom thickness of approximately 0.09 nm make up a proportion of the total nBN sample of at least 99% by weight, or at least 95% by weight, or at least 90% by weight, or at least 85% by weight, or at least 80% by weight, or at least 70% by weight, or at least 60% by weight, or at least 50% by weight, or at least 40% by weight.

The nBN described herein may have any suitable average particle size. In some embodiments, the average particle size is between 1 μm and 500 μm, or is between 1 μm and 100 μm, or between 100 μm and 250 μm, or between 250 μm and 500 μm, or between 100 μm and 500 μm, or between 400 μm and 500 μm. In other embodiments, the average particle size is less than 500 μm, or less than 400 μm, or less than 300 μm, or less than 200 μm, or less than 100 μm, or less than 50 μm, or less than 10 μm, or is 500 μm, 400 μm, 300 μm, 200 μm, 100 μm, 50 μm, or 10 μm.

The nBN described herein may have any suitable specific surface area. The nBN may have a specific surface area of up to about 2000 m²/g, or of from 500 to 1000 m²/g, or of from 1000 to 2000 m²/g, or of from 500 to 2000 m²/g, or of from 100 to 500 m²/g, or of from 300 to 800 m²/g. The nBN may have a surface area of at least 100 m²/g, or at least 200 m²/g, or at least 500 m²/g, or at least 750 m²/g, or at least 1000 m²/g, or at least 1250 m²/g, or at least 1500 m²/g, or at least 1750 m²/g, or at least 2000 m²/g. The nBN may have a surface area of 100, 200, 500, 750, 1000, 1250, 1500, 1750 or 2000 m²/g. In one embodiment, the specific surface area is calculated using a BET model. Methods of measuring the surface area of a sample will be known to persons skilled in the art but may include gas adsorption (such as N₂ adsorption).

The nBN described herein may have any suitable pore size distribution and/or average pore volume. The nBN may have an average pore size diameter of up to about 15 nm, or of from 2 to 15 nm, or of from 5 to 10 nm, or of from 7 to 15 nm, or of from 1 to 15 nm, or of from 10 to 15 nm. The nBN may have an average pore size diameter of 1, 2, 4, 6, 8, 10, 12, 14 or 15 nm. The pore size distribution may be bimodal. In such embodiments, the material may comprise nanopores and micropores. The nBN may have an average pore volume of up to about 1 cm³/g, or of from 0.01 to 0.1 cm³/g, or of from 0.1 to 0.5 cm³/g, or of from 0.5 to 1 cm³/g, or of from 0.25 to 0.75 cm³/g, or of from 0.5 to 0.8 cm³/g. The nBN may have an average pore volume of 0.01, 0.05, 0.1, 0.15, 0.2, 0.3, 0.4, 0.5, 0.6, 0.7, 0.8, 0.9 or 1 cm³/g.

Boron exists in two isotopic forms, boron-10 and boron-11. Although the nBN compounds described herein may contain boron in its naturally occurring proportions of ¹⁰B:¹¹B of approximately 1:4, it is contemplated herein that the nBN is isotopically enriched in ¹¹B. In one embodiment, the nBN described herein may have a ¹⁰B:¹¹B ratio of about 20:80, or of up to about 15:85, or of up to about 10:90, or of up to about 5:95, or of up to about 1:99, or of up to about 0:100. In another embodiment, the nBN may have a ¹⁰B:¹¹B ratio of between about 20:80 and about 0:100, or between 20:80 and 10:90, or between 10:90 and 1:99, or between 15:85 and 5:95, or between 1:99 and 20:80, or may have a ¹⁰B:¹¹B ratio of about 20:80, about 15:85, about 10:90, 5:95, 1:99, or 0:100. Methods of producing isotopically enriched ¹¹B nBN compounds will be known to those skilled in the art and may comprise using commercially available ¹¹B-enriched precursor materials.

The nBN according to the present invention comprises hydrogen. In preferred embodiments, hydrogen is loaded into the nBN in a step separate from, and subsequent to, synthesis of the nBN matrix. Accordingly, in preferred embodiments, the nBN according to the present invention comprises exogenous hydrogen. In this context, “exogenous” refers to the hydrogen coming from a source external to the precursor chemicals used to synthesise the nBN matrix. The hydrogen may be loaded into the nBN using any suitable processes. In some embodiments, the hydrogen may be loaded into the nBN as molecular hydrogen, H₂ gas, under pressure. In some embodiments, the hydrogen may be loaded into the nBN at liquid nitrogen temperatures of about 77 K. The hydrogen may be encapsulated in the nBN. The nBN may act as a hydrogen storage matrix. The hydrogen may be reversibly stored in the nBN. The hydrogen may be irreversibly stored in the nBN. The hydrogen may remain in the nBN under the conditions used to conduct the fusion reaction. The hydrogen may be physisorbed in the nBN material. The hydrogen may be chemisorbed on the nBN material. There may be a mixture of chemisorbed and physisorbed hydrogen in the nBN material. In a preferred embodiment, the hydrogen is loaded into the nBN prior to compacting the nBN into a simple or complex shape as described below.

The nBN as described herein may comprise any suitable concentration of hydrogen. In one embodiment, the nBNs comprise hydrogen in an amount that enables an avalanche fusion reaction to be sustained. In one embodiment, the nBNs comprise hydrogen in an amount that enables tertiary or higher nth order fusion reactions to occur in the material.

In some embodiments, the nBN may comprise up to 100 wt % hydrogen, which may be molecular H₂, or up to 90 wt % hydrogen, or up to 80 wt % hydrogen, or up to 75 wt % hydrogen, or up to 60 wt % hydrogen, or up to 50 wt % hydrogen, or up to 30 wt % hydrogen, or up to 30 wt % hydrogen, or up to 20 wt % hydrogen, or up to 10 wt % hydrogen, or up to 6 wt % hydrogen, or up to 5.5 wt %, up to 5 wt %, up to 4.5 wt %, up to 4 wt %, up to 3.5 wt %, up to 2 wt % or up to 1 wt % hydrogen. In some embodiments, the nBN may comprise between 0.1 and 6 wt %, or between 2 and 6 wt %, or between 4 and 6 wt %, or between 2 and 5 wt %, or between 5 and 6 wt %, or between 2 and 6 wt %, or may comprise 1, 2, 3, 4, 4.5, 5, 5.5 or 6 wt % hydrogen. In other embodiments, the nBN may comprise between 80 wt % and 100 wt % hydrogen, or between 50 and 75 wt % hydrogen, or between 25 and 50 wt % hydrogen, or between 5 and 25 wt % hydrogen, or between 4 and 30 wt % hydrogen, or may comprise at least about 4 wt % hydrogen, or may comprise at least about 5 wt % hydrogen, or at least about 10 wt % hydrogen, or at least about 20 wt % hydrogen, or at least about 30 wt % hydrogen, or at least about 40 wt % hydrogen, or at least about 50 wt % hydrogen, or at least about 60 wt % hydrogen, or at least about 70 wt % hydrogen, or at least about 80 wt % hydrogen, or may comprise about 90 wt %, or about 80 wt %, or about 70 wt %, or about 60 wt %, or about 50 wt %, or about 40 wt %, or about 30 wt %, or about 20 wt %, or about 10 wt %, or about 5 wt %, or about 4 wt % hydrogen. In these embodiments, the concentration of hydrogen may be measured at 77 K and 1 atm. In these embodiments, the concentration of hydrogen may be measured at 293 K and 1 atm.

In some embodiments, the nBN may comprise up to 100 at % hydrogen, which may be H atoms, or up to 90 at % hydrogen, or up to 80 at % hydrogen, or up to 75 at % hydrogen, or up to 60 at % hydrogen, or up to 50 at % hydrogen, or up to 30 at % hydrogen, or up to 30 at % hydrogen, or up to 20 at % hydrogen, or up to 10 at % hydrogen, or up to 5 at % hydrogen, or up to 2.5 at % hydrogen. In some embodiments, the nBN may comprise between 5 and 10 at %, or between 10 and 30 at %, or between 20 and 95 at %, or between 30 and 90 at %, or between 40 and 85 at %, or between 50 and 70 at %, or between 50 and 75 at %, or may comprise 20, 30, 40, 50, 60, 70, 80, 90 or 95 at % hydrogen. In other embodiments, the nBN materials described herein may comprise between 40 and 85 at % hydrogen at 25° C. and 1 atm. In one embodiment, the nBN materials described herein may comprise between 50 and 70 at % hydrogen at 25° C. and 1 atm.

In some embodiments, the amount of hydrogen in the nBN material is adjustable within a known range. In such embodiments, adjustment of the amount of hydrogen may be used to control initiation of the HB11 fusion reaction and the magnitude of the avalanche fusion effect. In one embodiment, an nBN as described herein may be loaded with between about 2 and about 6 wt % hydrogen depending on the HB11 reaction conditions. In one embodiment, an nBN as described herein may be loaded with between about 40 and about 85 at % hydrogen depending on the HB11 reaction conditions.

In a preferred embodiment, the nBN is in the form of BN nanosheets comprising physisorbed hydrogen, chemisorbed hydrogen, or a mixture of physisorbed and chemisorbed hydrogen. The physisorbed and/or chemisorbed molecular hydrogen may be present in the BN nanosheets in an amount of up to about 6 wt %, or between about 4 and about 6 wt %, or between about 2 and about 5 wt %, or between about 5 and about 6 wt %. The physisorbed and/or chemisorbed hydrogen may be present in the BN nanosheets in an amount of up to about 95 at %, or between about 30 and about 95 at %, or between about 40 and about 85 at %, or between about 50 and about 70 at %.

The hydrogen may be present in the nBN such that there is an atomic ratio of H:B of between about 1:2 and 2:1. In some embodiments, the atomic ratio of H:B is between 1:1 and 1.5:1, or between 1:2 and 1:1.5, or between 1:1.5 and 1.5:1, or between 1.5:1 and 2:1, or between 1.25:1 and 1.75:1, or between 1.3:1 and 1.7:1. In other embodiments, the atomic ratio of H:B is at least 1:2, or at least 1:1.5, or at least 1:1, or at least 1.2:1, or at least 1.4:1, or at least 1.6:1, or at least 1.8:1 or at least 2:1, or is about 1:2, 1:1.5, 1:1, 1.2:1, 1.4:1, 1.6:1, 1.8:1 or 2:1. The hydrogen may be present in the nBN such that there is a molar ratio of H₂:BN of between about 1:2 and 2:1. In some embodiments, the molar ratio of H₂:BN is between 1:1 and 1.5:1, or between 1:2 and 1:1.5, or between 1:1.5 and 1.5:1, or between 1.5:1 and 2:1, or between 1.25:1 and 1.75:1, or between 1.3:1 and 1.7:1. In other embodiments, the molar ratio of H₂:BN is at least 1:2, or at least 1:1.5, or at least 1:1, or at least 1.2:1, or at least 1.4:1, or at least 1.6:1, or at least 1.8:1 or at least 2:1, or is about 1:2, 1:1.5, 1:1, 1.2:1, 1.4:1, 1.6:1, 1.8:1 or 2:1. The hydrogen may be present in the nBN such that there is a mass ratio of H₂:BN of between about 1:2 and 2:1. In some embodiments, the mass ratio of H₂:BN is between 1:1 and 1.5:1, or between 1:2 and 1:1.5, or between 1:1.5 and 1.5:1, or between 1.5:1 and 2:1, or between 1.25:1 and 1.75:1, or between 1.3:1 and 1.7:1. In other embodiments, the mass ratio of H₂:BN is at least 1:2, or at least 1:1.5, or at least 1:1, or at least 1.2:1, or at least 1.4:1, or at least 1.6:1, or at least 1.8:1 or at least 2:1, or is about 1:2, 1:1.5, 1:1, 1.2:1, 1.4:1, 1.6:1, 1.8:1 or 2:1.

Advantageously, the nBN comprising hydrogen described herein is in the form of a powder capable of being formed into a variety of shapes. Accordingly, the powder may be formed into simple or complex shapes depending on the requirements of the fusion reactor used. In some embodiments, the powder may be compressible and/or compactable by powder processing methods such as pressing. Methods of pressing powders are known in the art and include using dies. In some embodiments, the nBNs comprising hydrogen described herein are pressed in dry form. In other embodiments, a solvent may be added to aid the pressing process.

In some embodiments, the powder is microcrystalline. In other embodiments, the powder is amorphous. In yet further embodiments, the powder is a mixture of microcrystalline and amorphous phases.

The nBNs comprising hydrogen described herein may be formed into any suitable shape. In some embodiments, the nBN comprising hydrogen described herein is formed into a pellet. In some embodiments, the pellet is cylindrical in shape. However, the nBNs comprising hydrogen may be formed into other shapes, including sheets, prisms, spheres, or conical shapes.

The nBNs comprising hydrogen described herein may be formed into shapes having any suitable dimensions. In some embodiments, the shapes may have a minimum dimension of about 0.1 cm, or a minimum dimension of about 1 cm, or a minimum dimension of about 10 cm. In other embodiments, the shapes may have a maximum dimension of about 0.1 cm, or a maximum dimension of about 1 cm, or a maximum dimension of about 10 cm. In some embodiments, the shape has one dimension of about 0.05 cm, or about 0.1 cm, or about 0.15 cm, or about 0.20 cm, or about 0.30 cm, or about 0.40 cm, or about 0.50 cm, or about 0.60 cm, or about 1 cm. In embodiments where the shape is cylindrical, the pellet of nBN comprising hydrogen may have a cylindrical height of about 0.1 cm, or about 0.05 cm, or about 0.15 cm, or about 0.20 cm, or about 0.30 cm, or about 0.40 cm, or about 0.50 cm, or about 0.60 cm, or about 1 cm, or about 10 cm. In embodiments where the shape is cylindrical, the pellet of nBN comprising hydrogen may have a circular cross section of diameter about 0.1 cm, or about 1 cm, or about 10 cm. In embodiments where the shape is a sheet, the sheet may have a maximum thickness of about 0.05 cm, or a maximum thickness of about 0.1 cm, or a maximum thickness of about 0.20 cm, or a maximum thickness of about 0.30 cm, or a maximum thickness of about 0.40 cm, or a maximum thickness of about 0.50 cm, or a maximum thickness of about 0.60 cm, or a maximum thickness of about 1 cm, or a maximum thickness of about 10 cm. In embodiments where the shape is a sheet, the sheet may have a maximum width of about 0.1 cm, or a maximum a width of about 1 cm, or a maximum a width of about 10 cm. In embodiments where the shape is a sheet, the sheet may have a maximum length of about 0.1 cm, or a maximum a length of about 1 cm, or a maximum a length of about 10 cm.

The nBNs comprising hydrogen described herein may have any suitable density. In one embodiment, nBNs comprising hydrogen may have a density of between 0.5 and 4 g/cm³, or of between 0.5 and 2 g/cm³, or of between 1 and 3 g/cm³, or of between 2 and 3 g/cm³, or of between 3 and 4 g/cm³, or of 0.5 g/cm³, 1.5 g/cm³, 1.5 g/cm³, 2.0 g/cm³, 2.5 g/cm³, 3.0 g/cm³, 3.5 g/cm³ or 4.0 g/cm³. The nBNs comprising hydrogen described herein may be compressed to any suitable density. In one embodiment, nBNs comprising hydrogen may be compressed to a density of between 0.5 and 4 g/cm³, or of between 0.5 and 2 g/cm³, or of between 1 and 3 g/cm³, or of between 2 and 3 g/cm³, or of between 3 and 4 g/cm³, or of 0.5 g/cm³, 1.5 g/cm³, 1.5 g/cm³, 2.0 g/cm³, 2.5 g/cm³, 3.0 g/cm³, 3.5 g/cm³ or 4.0 g/cm³.

The nBNs comprising hydrogen as described herein may sustain an avalanche fusion reaction. In one embodiment, tertiary or higher nth order fusion reactions occur in the nBNs comprising hydrogen described herein.

Also described herein is a method of producing energy by proton-boron nuclear fusion, comprising non-thermally igniting an nBN comprising hydrogen. In some embodiments, the nBN comprising hydrogen is a target. Accordingly, in one embodiment there is described a method of producing energy by proton-boron nuclear fusion, comprising non-thermally igniting a target comprising hydrogen in an nBN matrix. It will be understood that all parameters disclosed herein describing the nBN are equally applicable to the nBN matrix.

Non-thermal ignition of the nBN is not limited to being achieved by any particular means. However, in preferred embodiments, non-thermal ignition is achieved by use of a laser emitting a laser beam. In preferred embodiments, a laser is used to ignite the fusion reaction by generating a plasma at the surface of the nBN comprising hydrogen. In one embodiment, the laser is a chirped pulse amplification (CPA) laser. In one embodiment, a single laser is used to ignite the target. In another embodiment, two or more lasers may be used. In such embodiments, the two or more lasers may have beams with independently selected properties including wavelength, intensity, pulse duration, pulse energy, etc. In some embodiments, the two or more lasers will have beams with different properties. In some embodiments, the two or more lasers will have beams with the same properties.

The laser beam may ignite the nBN comprising hydrogen by directly irradiating it. The laser beam may alternatively ignite the nBN comprising hydrogen by indirectly irradiating it through use of one or more intermediate reflective surfaces. In one embodiment, the intermediate reflective surfaces are mirrors. The incident laser beam may be focused onto the nBN. The nBN may be free-standing before the laser with one surface in the nominal focal plane of the laser. In one embodiment, focusing of the laser beam is achieved through use of a lens. The laser beam may be directed to or focused onto the nBN so as to have any suitable focal spot. In one embodiment, the focal spot may have a diameter of between 4 μm and 10 μm, between 5 μm and 1000 μm, or of between 5 μm and 50 μm, or of between 10 μm and 100 μm, or of between 100 μm and 500 μm, or of between 5 μm and 500 μm, or of between 500 μm and 1000 μm. In one embodiment, the focal spot may have a diameter of about 4 μm, 5 μm, 6 μm, 10 μm, 50 μm, 100 μm, 250 μm, 500 μm, 750 μm, or 1000 μm. The focal spot may be defined as the area containing 50% of the pulse energy. The embodiments described in this paragraph may be useful for generating energy from the fusion reaction.

In another embodiment, the laser beam may directly irradiate a pitcher material, which acts as a proton source, accelerated protons from which collide with the nBN comprising hydrogen (the catcher). This embodiment may be useful for diagnosing the fusion reaction. This embodiment may be referred to as “pitcher/catcher” geometry. The pitcher material may be any suitable material known in the art. In one embodiment, the pitcher material comprises a metal. In one embodiment, the pitcher material comprises copper or gold. In one embodiment, the pitcher material comprises a polymer. In one embodiment, the polymer is polyethylene. In another embodiment, the pitcher material comprises diamond-like carbon. Any suitable pitcher material shape or thickness may be used. In one embodiment, the pitcher material is in the form of a thin sheet or foil. In one embodiment, the pitcher material, such as in the form of a thin sheet or foil, is between 0.1 and 25 μm thick, or between 0.1 and 0.5 μm thick, or between 0.5 and 1.0 μm thick, or between 1.0 and 5.0 μm thick, or between 5.0 and 10 μm thick, or between 10 and 20 μm thick, or is 0.1 μm, 0.25 μm, 0.5 μm, 1.0 μm, 5 μm, 10 μm, 15 μm, 20 μm, or 25 μm thick. In one embodiment, the pitcher material is 20-μm thick copper. In one embodiment, the pitcher material is 0.5 thick gold. In one embodiment, the pitcher material is 0.25 μm thick gold. The gold may be hydrogen enriched. In one embodiment, the pitcher material is 0.5 μm thick polyethylene. In one embodiment, the pitcher material is 0.1 μm thick diamond-like carbon.

The pitcher material may be positioned at any suitable distance from the nBN comprising hydrogen target (catcher). In one embodiment, the pitcher material may be up to 10 cm from the catcher as measured linearly from a face of the pitcher material in the focal plane of the laser to a face of the nBN comprising hydrogen target (catcher), or up to 8 cm from the catcher, or up to 6 cm from the catcher, or up to 5 cm from the catcher, or up to 4 cm from the catcher, or up to 3 cm from the catcher, or up to 2 cm from the catcher, or 10 cm, 9 cm, 8 cm, 7 cm, 6 cm, 5 cm, 4 cm, 3 cm, or 2 cm from the catcher as measured linearly.

The laser unit emitting the laser beam may be positioned at any suitable distance from the nBN target. In one embodiment, the nBN target and laser unit are separated by a distance of up to 20 cm, or up to 50 cm, or up to 1 m, or up to 2 m, or up to 3 m, or by a distance of between 0.5 and 1.5 m, or between 0.1 and 0.5 m, or between 0.2 and 2 m, or between 1.5 m and 2.5 m, or by a distance of 0.2 m, 0.5 m, 1.0 m, 1.5 m, 2.0 m, 2.5 m, or 3.0 m. In embodiments where a pitcher/catcher geometry is used, the laser unit emitting the laser beam may be positioned at any suitable distance from the pitcher material. In one embodiment, the pitcher material and laser unit are separated by a distance of up to 20 cm, or up to 50 cm, or up to 1 m, or up to 2 m, or up to 3 m, or by a distance of between 0.5 and 1.5 m, or between 0.1 and 0.5 m, or between 0.2 and 2 m, or between 1.5 m and 2.5 m, or by a distance of 0.2 m, 0.5 m, 1.0 m, 1.5 m, 2.0 m, 2.5 m, or 3.0 m.

The laser may emit light of any suitable wavelength. In one embodiment, the laser emits light having a wavelength of between 1 and 100 nm, or of between 1 and 50 nm, or of between 1 and 250 nm, or of between 250 nm and 2000 nm, or of between 500 nm and 1000 nm, or of between 500 nm and 2000 nm, or between 1000 nm and 1500 nm, or between 1500 nm and 2000 nm. In a preferred embodiment, the laser emits light at a wavelength of between 700 nm and 1500 nm. In one embodiment, the laser emits light at a wavelength of 1315 nm. In one embodiment, the laser emits light at a wavelength of 1057 nm. In one embodiment, the laser emits light at a wavelength of approximately 10 nm. A suitable laser system for emitting a laser beam for use in the non-thermal ignition methods described herein includes iodine lasers such as the PALS laser (Jungwirth et al. (2001) Phys. Plasmas 8, 2495). In other embodiments, a suitable laser system for emitting a laser beam for use in the non-thermal ignition methods described herein is the LFEX PW-laser (Yogo et al. (2017) Sci Rep., 7, 42451; Morace et al. (2019) Nat. Comm., 10, 2995).

The laser may generate light pulses having any suitable pulse duration. In some embodiments, the laser may generate light pulses having a FWHM pulse duration of between 1 ps and 100 ns, or of between 1 ps and 10 ps, or of between 1 ps and 100 ps, or of between 10 ps and 100 ps, or of between 100 ps and 500 ps, or of between 500 ps and 1 ns, or of between 1 ns and 10 ns, or of between 10 ns and 100 ns. In other embodiments, the laser may generate light pulses having a FWHM pulse duration of less than 1 ps, or less than 10 ps, or less than 100 ps, or less than 500 ps, or less than 1 ns, or less than 5 ns, or less than 10 ns, or less than 100 ns. In further embodiments, the laser may generate light pulses having a FWHM pulse duration of 1 ps, 5 ps, 10 ps, 100 ps, 500 ps, 1 ns, 10 ns or 100 ns. In yet further embodiments, the laser may generate light pulses having a FWHM pulse duration of between 1 as and 1 fs, or of between 1 as and 500 as, or of between 500 as and 1 fs, or of between 1 fs and 1000 fs, or of between 1 fs and 10 fs, or of between 1 fs and 100 fs, or of between 10 fs and 100 fs, or of between 100 fs and 500 fs, or of between 500 fs and 1000 fs, or of between 100 fs and 1 ns, or between 1 as and 1 fs. In other embodiments, the laser may generate light pulses having a FWHM pulse duration of less than 1 fs, or less than 10 fs, or less than 100 fs, or less than 500 fs, or less than 750 fs, or less than 1000 fs. In further embodiments, the laser may generate light pulses having a FWHM pulse duration of about 1 as, 5 as, 10 as, 100 as, 500 as, about 1 fs, about 5 fs, about 10 fs, about 100 fs, about 150 fs, about 300 fs, about 400 fs, about 500 fs, about 750 fs, or about 1000 fs.

The laser may have any suitable peak current. In some embodiments, the laser may have a peak current of between 1 and 4 A, or of between 1 and 3 A, or of between 2 and 4 A, or of between 3 and 4 A, or of 1, 1.5, 2, 2.5, 3, 3.5 or 4 A.

The laser may deliver light pulses having any suitable pulse energy. In some embodiments, the laser may deliver light pulses having a pulse energy of between 0.1 and 5 J, or of between 0.1 and 10 J, or of between 0.1 and 1 J, or of between 5 and 200 J, or of between 5 and 100 J, or of between 10 and 50 J, or of between 10 and 100 J, or of between 10 and 150 J, or of between 25 and 200 J, or of between 50 and 100 J, or of between 100 and 150 J, or of between 75 and 125 J, or of between 100 and 200 J, or of between 150 and 200 J. In some embodiments, the laser may deliver light pulses having a pulse energy of between 200 and 50000 J, or of between 200 and 2000 J, or of between 500 and 1000 J, or of between 500 and 3000 J, or of between 200 and 3000 J, or of between 800 and 2000 J, or of between 1000 and 5000 J, or of between 5000 and 10000 J, or of between 10000 and 25000 J, or of between 25000 and 40000 J, or of between 30000 and 50000 J. In other embodiments, the laser may deliver light pulses having a pulse energy of up to up to 50000 J, or up to 30000 J, or up to 20000 J, or up to 10000 J, or up to 8000 J, or up to 6000 J, or up to 4000 J, or up to 3000 J, or up to 2000 J, or up to 1000 J, or up to 500 J, or light pulses having a pulse energy of about 0.1 J, about 1 J, about 5 J, about 10 J, about 20 J, about 50 J, about 100 J, about 115 J, about 125 J, about 150 J, about 200 J, about 500 J, about 1000 J, about 1500 J, about 2000 J, about 5000 J, about 7500 J, about 10000 J, about 20000 J, about 30000 J, about 40000 J or about 50000 J.

In one embodiment, the laser is an iodine laser emitting light at a wavelength of 1315 nm, having a FWHM pulse duration of 0.3 ns and a pulse energy of 600 J. In another embodiment, the laser emits light at a wavelength of 1050 nm, having a FWHM pulse duration of 2.6 ps and a pulse energy of 1400 J.

The laser beam may have any suitable intensity on the target. The intensity of the laser beam on the target may be adjusted by modifying parameters of the laser beam such as the pulse energy, pulse duration and focal spot size. In one embodiment, the laser beam may have an intensity of between 1×10¹⁵ and 1×10²⁰ W/cm², or of between 1×10¹⁶ and 1×10¹⁸ W/cm², or of between 1×10¹⁵ and 1×10¹⁷ W/cm², or of between 1×10¹⁷ and 1×10²⁰ W/cm², or of between 1×10¹⁵ and 1×10¹⁹ W/cm², or of between 1×10¹⁹ and 1×10²¹ W/cm², or of between 1×10²⁰ and 1×10²¹ W/cm², or of between 1×10¹⁹ and 1×10²² W/cm², or of at least 1×10¹⁵ W/cm², or of at least 1×10¹⁶ W/cm², or of at least 1×10¹⁷ W/cm², or of at least 1×10¹⁸ W/cm², or of at least 1×10¹⁹ W/cm², or of at least 1×10²⁰ W/cm², or of at least 1×10²¹ W/cm², or of at least 1×10²² W/cm², or of at least 1×10²³ W/cm², or of at least 1×10²⁴ W/cm², or of at least 1×10²⁵ W/cm², or of at least 1×10²⁶ W/cm² on the target. In other embodiments, the laser beam may have an intensity of 1×10¹⁵ W/cm², or of 1×10¹⁶ W/cm², or of 1×10¹⁷ W/cm², or of 5×10¹⁷ W/cm², or of 1×10¹⁸ W/cm², or of 5×10¹⁸ W/cm², or of 1×10¹⁹ W/cm², or of 1×10²⁰ W/cm², or of 5×10²⁰ W/cm², or of 1×10²¹ W/cm², or of 1.5×10²¹ W/cm² or of 1×10²² W/cm², or of 1×10²³ W/cm², or of 1×10²⁴ W/cm², or of 1×10²⁵ W/cm², or of 1×10²⁶ W/cm² on the target. A plasma mirror may be used to ensure that no pre-pulse below a predetermined intensity interacts with the target. In one embodiment, the predetermined intensity is about 1×10¹⁷ W/cm².

The laser pulse contrast ratio (LPCR), which is the ratio between the peak pulse intensity and the pre-pulse intensity, may be any suitable LPCR. In one embodiment, the LPCR is less than 1×10⁹, or less than 5×10⁸, or less than 1×10⁸, or less than 5×10⁷, or less than 1×10⁷, or less than 5×10⁶, or less than 1×10⁶, or less than 5×10⁵, or less than 1×10⁵, or less than 5×10⁴, or less than 1×10⁴, or less than 5×10³. In one embodiment, the LPCR is between about 1×10⁸ and about 1×10⁵, or between about 1×10⁸ and about 1×10⁷, or between about 1×10⁷ and about 1×10⁶, or between about 1×10⁶ and about 1×10⁵, or between about 1×10⁸ and about 1×10⁶, or between about 1×10⁷ and about 1×10⁵. In one embodiment, the LPCR is 1×10⁸, or 5×10⁷, or 1×10⁷, or 5×10⁶, 1×10⁶, or 5×10⁵, or 1×10⁵, or 5×10⁴, or 1×10⁴, or 5×10³. The LPCR may be adjusted using a plasma mirror.

The methods herein ignite a fusion reaction that may yield any suitable number of alpha particles per shot of the laser beam. In one embodiment, the fusion reaction may yield at least 1×10⁸ α/sr/shot, or at least 1×10⁹ α/sr/shot, or at least 1×10¹⁰ α/sr/shot, or at least 1×10¹¹ α/sr/shot, or at least 1×10¹² α/sr/shot, at least 1×10¹³ α/sr/shot, or at least 1×10¹⁴ α/sr/shot, or at least 2×10¹⁴ α/sr/shot, or at least 5×10¹⁴ α/sr/shot, or at least 7×10¹⁴ α/sr/shot, or at least 1×10¹⁵ α/sr/shot, or at least 5×10¹⁵ α/sr/shot, or at least 7×10¹⁵ α/sr/shot, or at least 1×10¹⁶ α/sr/shot, or at least 2×10¹⁶ α/sr/shot, or at least 5×10¹⁶ α/sr/shot. In other embodiments, the fusion reaction may yield between 1×10¹⁴ α/sr/shot and 1×10¹⁷ α/sr/shot, or between 1×10¹⁴ α/sr/shot and 1×10¹⁵ α/sr/shot, or between 1×10¹⁵ α/sr/shot and 1×10¹⁶ α/sr/shot, or between 1×10¹⁶ α/sr/shot and 1×10¹⁷ α/sr/shot, or may yield 1×10⁸ α/sr/shot, 1×10⁹ α/sr/shot, 1×10¹⁰ α/sr/shot, 1×10¹¹ α/sr/shot, 1×10¹² α/sr/shot, 1× 10¹³ α/sr/shot, 1×10¹⁴ α/sr/shot, 5×10¹⁴ α/sr/shot, 1×10¹⁵ α/sr/shot, 5×10¹⁵ α/sr/shot, 1×10¹⁶ α/sr/shot, 2×10¹⁶ α/sr/shot, 5×10¹⁶ α/sr/shot, 7×10¹⁶ α/sr/shot, or 1×10¹⁷ α/sr/shot.

The alpha particles produced by the fusion reaction may have any kinetic energy. In some embodiments, the alpha particles produced by the fusion reaction may have a kinetic energy of up to 20 MeV, or up to 15 MeV, or up to 10 MeV, or up to 5 MeV, or up to 1 MeV, or up to 0.5 MeV, or of between 1 MeV and 10 MeV, or between 5 MeV and 20 MeV, or between 5 MeV and 15 MeV, or between 10 MeV and 20 MeV, or of between 8 MeV and 10 MeV, or of between 7 MeV and 12 MeV, or of 0.5, 1, 2, 4, 6, 8, 10, 12, 14, 16, 18, or 20 MeV.

Also described herein is a system for conducting non-thermal ignition proton-boron nuclear fusion comprising: a target comprising hydrogen in an nBN matrix, and a laser positioned to irradiate the target and thereby initiate a nuclear fusion reaction. In some embodiments, there is described a system for conducting non-thermal ignition proton-boron nuclear fusion comprising: a target comprising hydrogen in an nBN matrix, wherein the target is confined in a magnetic field; and a laser positioned to irradiate the target and thereby initiate a nuclear fusion reaction.

The non-thermal ignition proton-boron nuclear fusion methods and systems herein may be utilised in any suitable manner, with applications not intended to be particularly limited. However, it is envisaged that applications utilising energy released by the fusion reaction when converted to electrical energy and applications utilising the momentum of particles released by the reaction to create thrust may be particularly relevant.

Accordingly, in one embodiment, the system herein for conducting non-thermal ignition proton-boron nuclear fusion comprises: a target comprising hydrogen in a boron nitride nanomaterial (nBN) matrix; a laser positioned to irradiate the target and thereby initiate a nuclear fusion reaction; and an assembly configured to convert energy from charged particles produced by the nuclear fusion reaction into electrical energy. In one embodiment, the target is confined in a magnetic field. Such systems may be used in place of tradition power-generation sources, including fossil fuel-based power stations and other nuclear fission-based power stations to generate energy for domestic and industrial purposes.

In another embodiment, there is disclosed herein a system for conducting non-thermal ignition proton-boron nuclear fusion comprising: a target; and, a laser positioned to irradiate the target and thereby initiate a nuclear fusion reaction, characterised in that the target comprises hydrogen in an nBN matrix. In one embodiment, the target is confined in a magnetic field.

In a further embodiment, there is disclosed herein a system for conducting non-thermal ignition proton-boron nuclear fusion comprising: a target; and a laser positioned to irradiate the target and thereby initiate a nuclear fusion reaction; and, an assembly configured to convert energy from charged particles produced by the nuclear fusion reaction into electrical energy, characterised in that the target comprises hydrogen in an nBN matrix. In one embodiment, the target is confined in a magnetic field.

In preferred embodiments, the system described herein is a fusion reactor.

The target comprises an nBN comprising hydrogen as described herein. It will be understood that all parameters disclosed herein describing the nBN are equally applicable to the nBN matrix.

The target in the systems described herein comprise an nBN comprising hydrogen. However, it will be understood that the target may comprise one or more additional components. In some embodiments, these additional components may include an outer casing, or may include an outer protective layer, or may include one or more outer layers that improve transmission of an incident laser beam to the nBN comprising hydrogen. The outer layer or casing may partially encapsulate the target, or it may fully encapsulate the target.

The target may be confined in a magnetic field. The target may be confined in a magnetic field having any suitable strength. In some embodiments, the magnetic field has a strength of at least 3 kT, or at least 4.5 kT, or at least 6 kT, or at least 8 kT, or at least 10 kT, or at least 12.5 kT, or of between 4.5 and 15 kT, or of between 8 and 12 kT, or of between 3 and 7 kT, or of between 10 and 15 kT, or of between 6 and 11 kT, or of about 3 kT, 4 kT, 5 kT, 6 kT, 7 kT, 8 kT, 9 kT, 10 kT, 11 kT or 12 kT. The magnetic field may be generated by any suitable device. In some embodiments, the magnetic field is created by magnetic field laser pulses.

The laser positioned to irradiate the target in the system described herein may have properties as described herein, including intensity, light wavelength, beam pulse energy, focal point diameter, and beam pulse duration. The laser may be positioned at any distance from the target as described herein. The laser may directly or indirectly irradiate the target as described herein. The system may comprise one laser or may comprise two or more lasers as described herein.

The assembly configured to convert energy from charged particles produced by the nuclear fusion reaction into electrical energy may take any suitable form. In one embodiment, the system comprises an energy conversion device comprising an electrically conductive component surrounding the target and the magnetic field confining the target. The energy conversion device may be configured to capture high energy α-particles released during the fusion reaction of the fusion target and convert them by means of high voltage direct current transmission into a discharge current.

The system, or in some embodiments fusion reactor, may have any suitable design. In one embodiment, a reactor as described in U.S. Pat. No. 10,410,752, the contents of which are incorporated herein by cross-reference in their entirety, is employed. In brief, in one embodiment a nuclear fusion reactor suitable for use with the nBNs comprising hydrogen as described herein comprises a magnetic field device for holding a fusion target with a magnetic field in a cylindrical reaction chamber, a magnetic field pulsed laser source for emitting magnetic field laser pulses, a fusion pulsed laser source for emitting fusion laser pulses, and an energy conversion device for converting the energy that is released from the nuclei that are produced during nuclear fusion.

The magnetic field device for generating a magnetic field in the reaction chamber may comprise two parallel metal plates, in one embodiment made of nickel, and having a thickness in one embodiment of 2 mm. The metal plates may be connected to one another via electrical conductors, which form two windings of a coil. One of the metal plates may have an opening through which the magnetic field laser pulse is beamed, in one embodiment with a duration of 1 ns to 2 ns and an energy of 10 kJ. The opening may be circular and have dimensions and/or geometry appropriate for magnetic field laser pulses having a certain intensity, diameter and profile. A second metal plate facing this opening may be provided with an absorption layer that serves to reduce the optical reflection of the magnetic field laser pulses and to increase the dielectric properties of the capacitor formed by the metal plates. The absorption layer is preferably disposed over the entire surface of the metal plate and is more preferably made of a foam material. In one embodiment, the foam material is polyethylene. The magnetic field laser pulses may be generated by a magnetic field pulsed laser source that contains, in one embodiment, a Nd-YAG laser and other optical components for directing the magnetic field laser pulses toward the magnetic field device. The plasma produced by each magnetic field laser pulse may generate a current surge in the windings with a magnetic field having, in one embodiment, a volume of a few cubic millimetres and several ns duration.

The magnetic field pulsed laser source and the fusion pulsed laser source may be coupled to a control unit configured to synchronise the magnetic field and fusion laser pulses with each other. A maximum magnetic field may be generated immediately before each fusion laser pulse arrives at the fusion target.

In one embodiment, the target may be in the form of a solid-state cylindrical body having a length of 1 cm and a diameter of 0.2 mm. The target may comprise a cover layer over the surface of the nBN comprising hydrogen which has a thickness of three laser vacuum wavelengths. The cover layer may comprise an element having an atomic weight greater than 100, in some embodiments comprising or consisting of silver. The cover layer may improve pulse transmission for generating a fusion flame in the target. The target may be held in a magnetic field device by quartz fibres.

In one embodiment, the magnetic field generating laser pulses generate a magnetic field having a field strength of 10 kT. The fusion target is placed in the reaction chamber and is acted on by the magnetic field within a time range of nanoseconds. During the period in which the magnetic field is generated, block ignition is generated in the fusion target by a fusion laser pulse.

In one embodiment, the assembly comprises an electrically conductive sphere encasing the target and magnetic field device, the sphere having a plurality of windows through which magnetic field laser pulses and fusion laser pulses are beamed. In this embodiment, energetic alpha particles generated by the fusion reaction reach the spherical energy conversion device and release their kinetic energy to the device, where the energy may be converted to high voltage direct current and subsequently transformed into conventional alternating current.

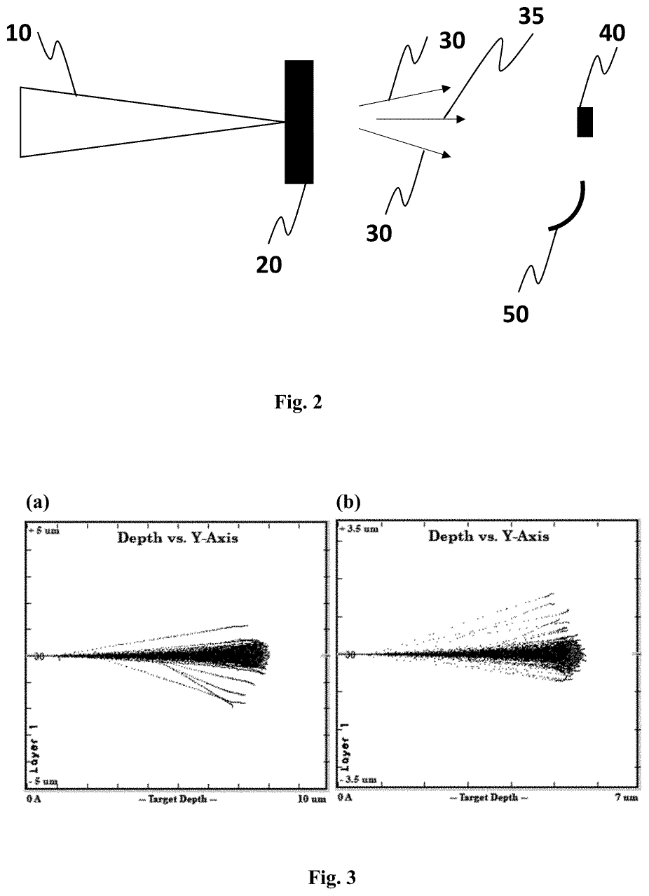

In one embodiment, an assembly as depicted in FIG. 2 may be used to conduct the non-thermal ignition proton-boron nuclear fusion reaction. As shown in FIG. 2, a laser 10 may deliver energy, in one embodiment 1.4 kJ in 2.6 ps, to a target 20. In some embodiments, the laser 10 may be a laser unit, or it may be a laser beam reflected from a plasma mirror or the like emitted by a laser unit located elsewhere in the assembly. In some embodiments, the target 20 is in the form of a compressed pellet comprising an nBN comprising hydrogen. The energy from the laser may have a focal spot size of ˜50 μm, which corresponds to an intensity on the target in some embodiments of approximately 2-3×10¹⁹ W/cm². The particle beam energy and number may be determined by a Thomson Parabola (TP) spectrometer 40 (equipped with an imaging plate) for characterisation of accelerated protons 35 and CR39 nuclear track detectors for detection of generated α-particles 30. CR39 is a transparent plastic that records the passage of high energy ions in tracks of damaged polymer, wherein the track width is proportional to the energy deposited. When positioned in one or more positions near to the laser target in the assembly, CR39 slides may thus provide small samples of the angular distribution (dN/dΩ) of ions emitted in the reaction. A single CR39 detector 50 shown in FIG. 2 at an angle of approximately 250 with respect to the incoming laser beam and at a distance of approximately 40 cm from the target may be used. However, in other embodiments, multiple detectors (not shown) may placed at different positions inside the target chamber surrounding the target to study the angular distribution of emitted α-particles. In one embodiment, at least 1, at least 2, at least 3, at least 4, at least 5, or at least 6 CR39 detectors may be positioned in the assembly. The CR39 detector(s) may be of any suitable size. In one embodiment, the CR39 detector(s) have dimensions of about 10 cm×5 cm×0.1 cm. The CR39 detector(s) may be positioned at any suitable distance from the target. The CR39 detector may be covered to prevent detection of low energy α-particles, where in one embodiment the detector is covered in 30 μm Al foil to prevent detection of α-particles having energies of <6.4 MeV. Time-of-flight (TOF) diamond detectors (not shown) may be used for verification of proton and α-particle emission. A TOF neutron detector (not shown) may be used to monitor potential concurrent nuclear reactions. The apparatus depicted in FIG. 2 may be used to correlate α-particle energies with the distance they travel through the CR39 detector material by comparison with tracks of α-particles of known energies.

In another embodiment, the system described herein for conducting non-thermal ignition proton-boron nuclear fusion comprising a target comprising hydrogen in an nBN matrix, and a laser positioned to irradiate the target and thereby initiate a nuclear fusion reaction, is a propulsion system. The propulsion system may be adapted for any suitable application, but it is envisaged that the propulsion system may be adapted to be particularly suitable for spacecraft propulsion, or may be useful in aircraft propulsion, and/or vehicular propulsion applications.

In some embodiments, the propulsion system generates thrust directly according to the conservation of momentum of alpha-particles explosively generated during the fusion reaction. In such embodiments, the propulsion system may comprise an assembly configured to direct and/or concentrate the alpha particles generated in the fusion reaction into a stream. In other embodiments, the propulsion system generates thrust indirectly by comprising an assembly configured to convert energy from charged particles produced by the nuclear fusion reaction into electrical energy as described above for powering an electric thruster. In some embodiments, the system provides propulsion via a combination of momentum-based thrust and electrical thrust.

In some embodiments, simulations may be used to investigate parameters of the HB11 fusion reaction. In one embodiment, the probability of an avalanche reaction may be calculated by multiplying the probability of an alpha particle from a primary HB11 fusion reaction colliding with a proton (hydrogen) in an elastic collision with the probability of the accelerated proton colliding with a boron-11 nuclei to create a secondary HB11 fusion reaction. Suitable programs for modelling such reactions include SRIM (Stopping and Range of Ions in Matter, J. F. Ziegler, J. P. Biersack and M. D. Ziegler (2008), SRIM Co.), a monte-carlo simulation that models atomic interactions between energetic ions as they pass through a target. In some embodiments, boundary conditions and particle energies are chosen based on the p-11B fusion energy cross section reported in Nevins, W. M. and R. Swain (2000) The thermonuclear fusion rate coefficient for p-11B reactions, Nuclear Fusion 40, 865. In some embodiments, the probabilities calculated in this way are plotted as a function of hydrogen concentration in the nBN material. However, in other embodiments, the hydrogen concentration may be fixed at a constant value and other parameters varied.

All references cited herein, including patents, patent applications, publications, and databases, are hereby incorporated by reference in their entireties, whether previously specifically incorporated or not.

### EXAMPLES

The present invention will now be described with reference to the following examples which should be considered in all respects as illustrative and non-restrictive.

### Example 1: Experimental Design—Fusion Reaction and Generation of α-Particles

With reference to the experimental set-up shown in FIG. 2, the laser 10 delivers 1.4 kJ in 2.6 ps to target 20 in the form of a compressed pellet comprising an nBN comprising hydrogen, with a focal spot size of ˜50 μm, which corresponds to an intensity on target of approximately 2-3×10¹⁹ W/cm². The particle beam energy and number are determined by a Thomson Parabola (TP) spectrometer 40 (equipped with an imaging plate) for characterization of accelerated protons 35 and CR39 nuclear track detectors for detection of generated α-particles 30. A single CR39 detector 50 is shown in FIG. 2 at an angle of approximately 25° with respect to the incoming laser beam and at a distance of approximately 40 cm from the target. However, multiple detectors (not shown) are placed at different positions inside the target chamber surrounding the target to study the angular distribution of emitted α-particles. The CR39 detector is covered in 30 μm Al foil to prevent detection of α-particles having energies of <6.4 MeV. Time-of-flight (TOF) detectors (not shown) are used for verification of proton and α-particle emission and a TOF neutron detector (not shown) monitors potential concurrent nuclear reactions.

The α-particle energies are correlated with the distance travelled through the CR39 detector material by comparison with tracks of α-particles of known energies.

### Example 2: Fusion Reaction and Generation of α-Particles from nBN Comprising Hydrogen

### Materials and Methods—Direct Irradiation

An experimental set-up corresponding to that depicted in FIG. 2 was applied to an experiment at the Texas Petawatt (TPW) laser facility. The laser 10 from the TPW facility operated near maximum amplification and was focused with an f/3 off-axis parabola. The average radius of the focal spot, defined as containing 50% of the pulse energy, was 4.85 μm and the pulse duration was near the nominal 150 fs. This delivered a pulse of 114 J at an intensity of 1.40×10²¹ W/cm² and wavelength of 1057 nm. The target 20 was two-dimensional boron nitride nanosheets containing about 4.1 wt % hydrogen. The target was pressed into a disk approximately 1.5 mm in thickness. The CR39 detector used to image the tracks of the non-thermal alpha-particle production were set at several positions.

### Results

An image of the CR39 detector placed at 90 degrees to the laser 10 (after its development to show the tracks) is shown in FIG. 5. An analysis of this and other CR39 detector images revealed that alpha-particle counts for direct irradiation of the nBN target comprising hydrogen varied between 10⁴ and 10⁶ α/millisteradian. These were extrapolated to estimate the total number of alpha particles generated by non-thermal laser fusion using an nBN nanosheet comprising hydrogen target of about 8.4×10⁸ α particles.

### Materials and Methods—Pitcher Catcher

The experimental set-up in FIG. 2 was applied to a further experiment at the Texas Petawatt (TPW) laser facility. The conditions generated for the laser 10 from the TPW facility operated near maximum amplification and was focused with an f/3 off-axis parabola. The average radius of the focal spot, defined as containing 50% of the pulse energy, was 4.85 μm and the pulse duration was near the nominal 150 fs. This delivered a pulse of 114 J at an intensity of 1.40×10²¹ W/cm² and wavelength of 1057 nm. In this experiment, the laser 10 was directed onto the surface of a thin target (the pitcher; not shown), which was composed of 0.25-μm thick gold with hydrogen as surface impurities, which provided the source of primary protons from the laser pulse. The “catcher” layer comprised either a control sample of crystalline BN (0.5 or 4 mm thick) or a material as described herein, nBN nanosheets comprising hydrogen (6 mm thick). The catcher was placed between 2.5 and 8 cm behind the pitcher. In this geometry, the “catcher” samples survived the laser pulse and could be used for analysis via Geiger counter. The Geiger counter was used to identify other isotopes produced in the reaction via their radioactive decay profiles, including their relative quantities by the ratio of other isotopes. Examples included ¹¹C produced from the reaction with a proton and ¹⁰B which has a half-life of 20.3 minutes, and ¹⁸F produced from the reaction between an alpha particle (generated from the p-¹¹B reaction) and nitrogen which has a half-life of 109.8 minutes. Based on this method of analysis, the nBN nanosheet comprising ˜4.1 wt % hydrogen target saw more p¹⁰B reactions than the targets comprising standard crystalline boron-nitride without hydrogen enrichment. Given the well-understood ratio of 3α and ¹¹C-production reactions (a factor of ˜25-100), this indicated that the nBN comprising hydrogen enhanced the yield of ¹¹B(p,2α)⁴He reactions as a catcher target.

### Example 3: Simulation of Avalanche Reaction in nBNs Comprising Hydrogen

The probability of an HB11 fusion event as a result of an “avalanche” reaction, P(avalanche), was calculated according to Equation 4:

P(avalanche)=P(E1)×P(E2) Equation 4

where Event 1 (E1) corresponds to the alpha particle from a primary HB11 fusion reaction colliding with a proton (hydrogen) in an elastic collision and Event 2 (E2) corresponds to the accelerated proton colliding with a boron-11 nuclei to create a secondary HB11 fusion reaction.

P(E1) and P(E2) were determined taking into account the hydrogen concentration of a BN sample varying from 1 at % to 95 at % and predicted using SRIM as follows:

P(E1) was calculated as the number of nuclear interactions with hydrogen atoms (protons) from 1000×2.9 MeV alpha-particles passing into a sample while the alpha particle has more than 273 keV of energy. The boundary condition of 2.9 MeV was chosen as it represents the energy of an alpha-particle from an HB11 reaction, while 273 KeV was chosen as the minimum energy capable of accelerating a proton (hydrogen) with enough energy to initiate an HB11 reaction based on the p-11B fusion energy cross section reported in Nevins and Swain (2000). A graphical representation of the model used to calculate P(E1) for a sample of 50 at % H is shown in FIG. 3(a). It indicates a damage cascade in a BN+H target from a 2.9 MeV alpha particle beam incident on the target from the left.

P(E2) was calculated as the number of nuclear interactions with boron atoms from 1000×600 KeV hydrogen particles passing into a target, where the hydrogen particles have more than 250 keV. 600 KeV was chosen to represent the peak of the H—B fusion cross section and therefore energy where an interaction leading to a fusion reaction is most likely to occur. 250 KeV was chosen as the lower limit of the HB11 cross section where a fusion reaction could reasonably occur, defined by σ(b) >0.1. A graphic representation of the model used to calculate P(E2) for a sample of 50 at % H is shown in FIG. 3(b). It shows a damage cascade in a BN+H target from a 600 KeV proton (hydrogen) beam incident on the target from the left.

In both calculations, the target was boron nitride with hydrogen concentration ranging from 1 to 95 at %. The density of the sample was assumed constant at 2.1 g/cm³.

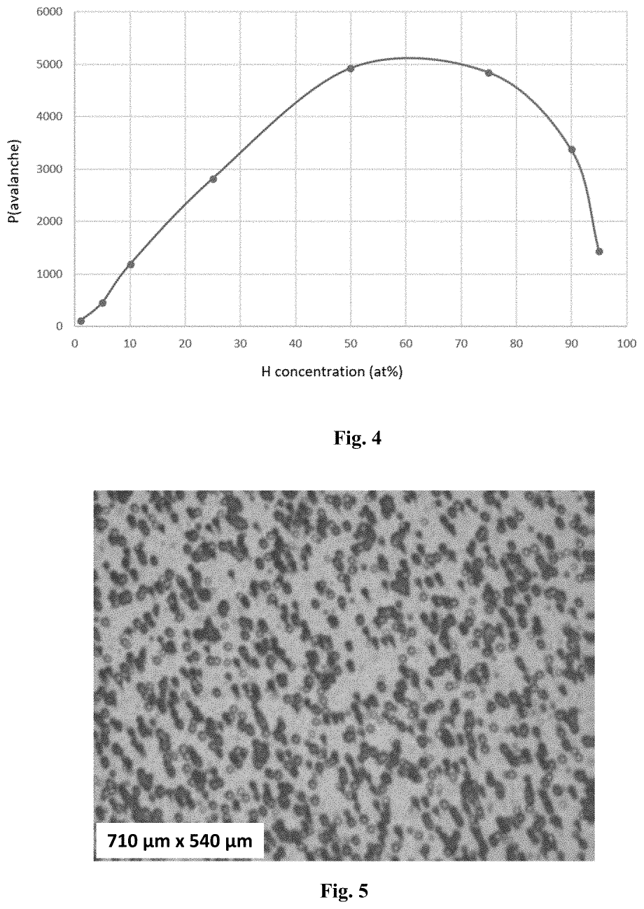

Table 1 below shows the values of P(E1) and P(E2) calculated via the SRIM simulation from each sample. The resulting plot of P(avalanche) calculated according to Equation 4 plotted as a function of at % H in the BN sample is shown graphically in FIG. 4.

TABLE 1
Results of SRIM simulations calculating probability
of HB11 fusion events using Equation 4

| | | P(E1): H-B | |
|---|---|---|---|
| Atomic % | P(E1): He-H | interactions | |
| of H in | interactions from 2.9 | from 600 | |
| nBN | MeV He ions | KeV H ions | P(avalanche) |
| 1 | 60 | 223 | 107 |
| 5 | 275 | 208 | 458 |
| 10 | 629 | 235 | 1183 |
| 25 | 1687 | 209 | 2821 |
| 50 | 3502 | 176 | 4931 |
| 75 | 5506 | 110 | 4845 |
| 90 | 6778 | 62 | 3362 |
| 95 | 7114 | 25 | 1423 |

This data suggests that a boron nitride sample containing between 50 at % and 75 at % hydrogen has the highest probability of producing an avalanche reaction.

Although the invention has been described with reference to specific examples, it will be appreciated by those skilled in the art that the invention may be embodied in many other forms in particular features of any one of the various described examples may be provided in any combination in any of the other described examples.

1. A method of producing energy by proton-boron nuclear fusion, comprising: non-thermally igniting a boron nitride nanomaterial (nBN) target by use of a laser emitting a laser beam, wherein the nBN comprises hydrogen.

2. The method of claim 1, wherein the nBN has at least one external dimension, or at least one surface structure dimension, of from about 0.05 nm to about 100 nm, preferably from about 0.85 nm to about 100 nm.

3. The method of claim 1, wherein the nBN comprises BN nanosheets, nanotubes, micro/mesoporous nanosheets and nanotubes, porous hexagonal BN, milled hexagonal BN, porous turbostratic BN, porous BN microbelts, porous sponge-like BN, multiwalled BN nanotubes, bamboo-like BN nanotubes, collapsed BN nanotubes, BN nanospheres, hollow BN nanospheres, BN nanomesh, BN nanowires, or BN aerogel, or a combination of any two or more of these.

4. The method of claim 1, wherein the nBN comprises BN nanosheets.

5. The method of claim 1, wherein the nBN comprises exfoliated BN nanosheets.

6. The method of claim 1, wherein the BN nanosheets have an external dimension that corresponds to a surface structure dimension of about 0.09 nm.

7. The method of claim 1, wherein the nBN has a surface area of from 500 to 2000 m²/g.

8. The method of claim 1, wherein the nBN comprises at least about 4 wt % hydrogen, preferably at least about 5 wt % hydrogen, more preferably at least about 20 wt % hydrogen, most preferably at least about 50 wt % hydrogen.

9. The method of claim 1, wherein the nBN comprises exogenous hydrogen.

10. The method of claim 1, wherein the nBN is enriched in ¹¹B.

11. The method of claim 1, wherein the nBN comprising hydrogen is formed into a pellet by powder pressing.

12. The method of claim 1, wherein the laser beam directly irradiates the nBN comprising hydrogen.

13. The method of claim 1, wherein the laser beam is focused onto the nBN comprising hydrogen.

14. The method of claim 1, wherein the laser beam emits light having a wavelength of between 500 nm and 2000 nm.

15. The method of claim 1, wherein the laser delivers laser beam pulses having a FWHM pulse duration of between 100 fs and 1 ns or between 1 ps and 10 ns.

16. The method of claim 1, wherein the laser delivers laser beam pulses having a pulse energy of between 10 and 3000 J, or between 10 and 200 J, or between 200 and 3000 J.

17. The method of claim 1, wherein the laser beam has an intensity of between 1×10¹⁵ and 1×10²⁰ W/cm² or between 1×10¹⁹ and 1×10²² W/cm² on the nBN comprising hydrogen.

18. The method of claim 1, wherein the laser is a chirped pulse amplification laser.

19. A system for conducting non-thermal ignition proton-boron nuclear fusion, comprising:
a target comprising hydrogen in a boron nitride nanomaterial (nBN) matrix; and
a laser positioned to irradiate the target and thereby initiate a nuclear fusion reaction.

20. The system of claim 19, further comprising:
an assembly configured to convert energy from charged particles produced by the nuclear fusion reaction into electrical energy.
